(19) United States
(12) Patent Application Publication
(10) Pub. No.: US 2019/0384543 A1
(43) Pub. Date: Dec. 19, 2019

(54) System and Methods for Reducing Time-To-First-Print in an Imaging Device

(71) Applicant: Lexmark International, Inc., Lexington, KY (US)

(72) Inventors: David J. Mickan, Lexington, KY (US); Kevin D. Schoedinger, Lexington, KY (US); William Shannon Spencer, Georgetown, KY (US)

(21) Appl. No.: 16/009,748

(22) Filed: Jun. 15, 2018

(51) Int. Cl. G06F 3/12

(52) U.S. Cl. CPC G06F 3/1221; G06F 3/1215; G06F 3/1229; G06F 3/1259; G06F 3/1217

(57) ABSTRACT

A method for reducing a time-to-first-print in an imaging device that includes tracking a set of sleep times between print jobs in an imaging device and determining whether a predetermined number of sleep times in the set of sleep times is reached; and upon a positive determination, identifying a first and a second most recent sleep times stored among the set of sleep times tracked; determining whether each of the first sleep time and the second sleep time is less than a predetermined threshold; and upon a positive determination, determining a value based on an average of the first sleep time and the second sleep time. The value is used as a period of time that the imaging device is powered at a snooze mode prior to transitioning to a sleep mode, and when a print job is received in the imaging device while in the snooze mode, the time-to-first-print from the snooze mode is faster than the time-to-first print when the print job is received while in the sleep mode.

### CROSS-REFERENCE TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC

None.

### BACKGROUND

### 1. Technical Field

The present invention relates to managing power modes in imaging devices, and more particularly to, reducing a time-to-first print in imaging devices from a low power mode.

### 2. Description of the Related Art

Imaging devices typically practice a sleep-print-sleep behavior when processing print jobs. A fixed time is commonly set in the imaging device for transitioning from a print-ready mode to a sleep mode. When entering the sleep mode following completion of a print job, an imaging device may be inaccessible since voltage power supplied to the imaging device may be removed to conserve power. The imaging device may also be disconnected from services accessible over the Internet when minimal to no power is supplied thereto. Connections or communications between the imaging device firmware and any replaceable components installed in the imaging device may be cut-off until a new print job is received. When the imaging device needs to exit the sleep mode to process a print job, a lengthy supply security chip initialization process may be performed before the imaging device may be used to perform the desired operations, thereby increasing a time-to-first-print in the imaging device. The transition process from a sleep mode to a print-ready mode may involve powering the data bus back on, establishing communications between the imaging device controller and the components installed, authenticating the supply items installed on the imaging device, and reading data included in the supply item chips to be able to use the supply item in the imaging device.

There is, therefore, a need to employ methods for reducing a time-to-first-print in the imaging device from a sleep mode. There is further a need to control power supplied to supply item chips.

### SUMMARY

A system and methods for reducing a time-to-first-print in an imaging device are disclosed. One example method includes tracking a set of sleep times between print jobs in an imaging device and determining whether a predetermined number of sleep times in the set of sleep times is reached; and upon a positive determination, identifying a first and a second most recent sleep times stored among the set of sleep times tracked; determining whether each of the first sleep time and the second sleep time is less than a predetermined threshold; and upon a positive determination, determining a value based on an average of the first sleep time and the second sleep time. The value is used as a period of time that the imaging device is powered at a snooze mode prior to transitioning to a sleep mode, and when a print job is received in the imaging device while in the snooze mode, the time-to-first-print from the snooze mode is faster than the time-to-first print when the print job is received while in the sleep mode.

In some example aspects, when the imaging device enters the sleep mode, connection between a supply item and a bus master in the imaging device is removed. In some other example aspects, the tracking the set of sleep times is performed following a determination that a fixed sleep time is reached. In yet other example aspects, the predetermined number of sleep times is at least 3.

In some example embodiments, the example method may include automatically transitioning the imaging device to the sleep mode upon a determination that each of the first sleep time and the second sleep time is greater than or equal to the predetermined threshold. In other example embodiments, the example method may further include determining whether the value is less than the predetermined threshold to determine whether to transition the imaging device to one of the sleep mode and the snooze mode. In some example aspects, upon a determination that the value is greater than or equal to the predetermined threshold, the predetermined threshold is set as a period of time that the imaging device is powered at the snooze mode.

In other example embodiments, the example method may include automatically transitioning the imaging device to the sleep mode when no print job is received in the imaging device following the period of time that the imaging device is in the snooze mode.

In other example embodiments, the determining the value may include identifying, among the set of sleep times, a second set of sleep times that are less than the predetermined threshold; determining an average of the second set of sleep times; and determining the value by multiplying the average to a predetermined multiplier.

In one example aspect, when the imaging device is in the snooze mode, a supply item chip in the imaging device remains connected with a controller of the imaging device. In other example aspects, the supply item chip is circuitry for one of: a toner cartridge, an imaging kit, a photoconductor unit, a maintenance kit, a waste bottle, and a staple cartridge for installation in the imaging device.

Methods of managing power consumed in an imaging device based on usage are also disclosed. One example method of managing power includes determining whether a predetermined value of sleep time samples has been reached following execution of an operation in a print-ready mode; upon a determination that the predetermined value has not been reached, determining whether a fixed sleep time is reached and switching the imaging device from the print-ready mode to a sleep mode; and upon a determination that the predetermined value has been reached, determining a snooze period based on an average time of a set of previous times that the imaging device is in the sleep mode and setting the imaging device from the print-ready mode to a snooze mode for the snooze period, wherein the imaging device is transitioned from the snooze mode to the sleep mode when the snooze period is over.

In some example embodiments, the example method of managing power may further determining, among a set of latest sleep times of the imaging device, a set of sleep times that is less than a predetermined threshold and identifying the average time using the set of sleep times that are less than the predetermined threshold. In some example aspects of this embodiment, when a print job is received in the imaging device while in the snooze mode, a time-to-first-print of the imaging device from the snooze mode is faster than a time-to-first print of the imaging device when the print job is received while in the sleep mode.

In other example aspects, when the imaging device is in the sleep mode, a power connection between each supply item installed in the imaging device and a bus controller of the imaging device is removed, and when the imaging device is in the snooze mode, each supply item installed in the imaging device and a bus controller of the imaging device remains connected to the power connection.

Example imaging devices for managing power modes have a non-transitory computer readable storage medium for storing one or more instructions for managing power modes are also disclosed. The one or more instructions include an instruction to determine whether a fixed time for transition to a sleep mode is reached following execution of an operation; store a time spent by the imaging device in the sleep mode following a determination that the fixed time is reached; perform the instructions to store the time spent by the imaging device in the sleep mode for a predetermined number of times; and determine a snooze period based on an average of the times spent by the imaging device in the sleep mode upon a determination that the predetermined number of times is reached, wherein the imaging device enters the snooze period prior the sleep mode.

In some example aspects, the execution of the operation includes processing a print job. In some example aspects, the imaging device is communicatively connected to a component circuitry of each removable component installed in the imaging device upon power on reset and wherein each component circuitry remains connected to the imaging device when in the snooze period. In other example aspects, communications between each component circuitry and a controller of the imaging device is cut off when the imaging device is in the sleep mode.

In some example imaging devices, the imaging device is transitioned to the sleep mode following a determination that the snooze period reached a predetermined threshold.

### BRIEF DESCRIPTION OF THE DRAWINGS

The above-mentioned and other features and advantages of the present disclosure, and the manner of attaining them, will become more apparent and will be better understood by reference to the following description of example embodiments taken in conjunction with the accompanying drawings. Like reference numerals are used to indicate the same element throughout the specification.

FIG. 1 is an illustrative diagram of an example imaging system, according to one example embodiment.

FIG. 2 is a block diagram showing different components of the example imaging device of FIG. 1.

FIG. 3 is a block diagram of an example shared bus system for the example imaging device of FIG. 1.

FIG. 4 is a flowchart showing an example method of initializing a supply item chip for the example imaging device of FIG. 1, according to one example embodiment.

FIG. 5 is a flowchart showing an example method for reducing a time-to-first-print in the example imaging device of FIG. 1 when printing from a sleep mode, according to one example embodiment.

FIG. 6 is a flowchart showing an example method for tracking a sleep time of the example imaging device of FIG. 1, according to one example embodiment.

### DETAILED DESCRIPTION OF THE DRAWINGS

It is to be understood that the disclosure is not limited to the details of construction and the arrangement of components set forth in the following description or illustrated in the drawings. The disclosure is capable of other example embodiments and of being practiced or of being carried out in various ways. For example, other example embodiments may incorporate structural, chronological, process, and other changes. Examples merely typify possible variations. Individual components and functions are optional unless explicitly required, and the sequence of operations may vary. Portions and features of some example embodiments may be included or substituted for those of others. The scope of the disclosure encompasses the appended claims and all available equivalents. The following description is, therefore, not to be taken in a limited sense, and the scope of the present disclosure is defined by the appended claims.

Also, it is to be understood that the phraseology and terminology used herein is for the purpose of description and should not be regarded as limiting. The use herein of “including”, “comprising”, or “having” and variations thereof is meant to encompass the items listed thereafter and equivalents thereof as well as additional items. Further, the use of the terms “a” and “an” herein do not denote a limitation of quantity but rather denote the presence of at least one of the referenced item.

In addition, it should be understood that example embodiments of the disclosure include both hardware and electronic components or modules that, for purposes of discussion, may be illustrated and described as if the majority of the components were implemented solely in hardware.

It will be further understood that each block of the diagrams, and combinations of blocks in the diagrams, respectively, may be implemented by computer program instructions. These computer program instructions may be loaded onto a general purpose computer, special purpose computer, or other programmable data processing apparatus to produce a machine, such that the instructions which execute on the computer or other data processing apparatus may create means for implementing the functionality of each block or combinations of blocks in the diagrams discussed in detail in the description below.

These computer program instructions may also be stored in a non-transitory computer-readable medium that may direct a computer or other programmable data processing apparatus to function in a particular manner, such that the instructions stored in the computer-readable medium may produce an article of manufacture, including an instruction means that implements the function specified in the block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus implement the functions specified in the block or blocks.

Accordingly, blocks of the diagrams support combinations of means for performing the specified functions, combinations of steps for performing the specified functions, and program instruction means for performing the specified functions. It will also be understood that each block of the diagrams, and combinations of blocks in the diagrams, may be implemented by special purpose hardware-based computer systems that perform the specified functions or steps, or combinations of special purpose hardware and computer instructions.

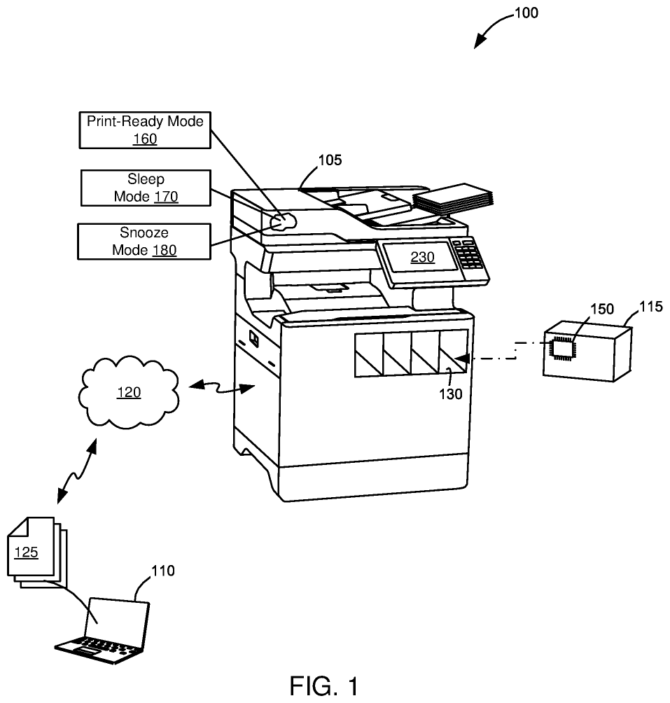

FIG. 1 is an illustrative diagram of an example imaging system 100 according to one example embodiment. System 100 includes an imaging device 105, a computing device 110, and a supply item 115. Computing device 110 may be connected to imaging device 105 over a network 120. Computing device 110 may store a document 125. Supply item 115 may be provided to a storage area or carriage 130 in imaging device 105. A user (not shown) of computing device 110 may send document 125 to imaging device 105 for printing. Upon receipt of document 125 from computing device 110, imaging device 105 may be powered to a print-ready mode 160.

Imaging device 105 may be any single function or multi-function device capable of printing, scanning, making copies, and/or other functionalities. Computing device 110 may be any computing device connected to imaging device 105 via network 120. Computing device 110 may be workstation computer or a mobile device such as a laptop, a smartphone, tablet, and the like.

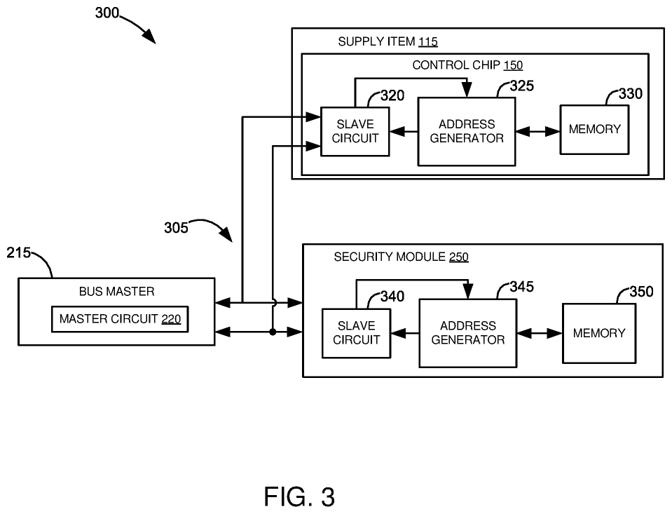

Supply item 115 may refer to any consumable unit in imaging device 105. Supply item 115 may be, for example, a toner cartridge, an imaging kit, a photoconductor unit, a maintenance kit, a waste bottle, and a staple cartridge. When installed, supply item 115 may allow imaging device 105 to perform an operation. Supply item 115 may include control chip 150 for communicating with imaging device 105. Supply item 115 may include a memory for storing data, such as memory 330 in FIG. 3. Memory 330 of supply item 115 may include a rated life or the predetermined level of use until end of life of supply item 115. A rated life of supply item 115 may be, for example, based on a number of pages processed in imaging device 105 while supply item 115 is in use.

Network 120 may refer to any structure that facilitates electronic communication between multiple components. Network 115 may include communications over the Internet. Network 120 may link components via a standard communication protocol, such as, for example, universal serial bus (USB), Ethernet or IEEE 802.xx. Network 120 may be wired, wireless, or a combination of both.

Document 125 may refer to an electronic document from computing device 110 for printing in imaging device 105. Document 125 may be comprised of text and/or images. Document 125 may be in a format for printing in imaging device 110. In one example embodiment, computing device 110 may include a print driver (not shown) for communicating with imaging device 105. Computing device 110 may send document 125 with the help of the print driver. In preparing document 125 for printing, the print driver may convert a file format of document 125 to a printable format.

For purposes of discussing the present disclosure, imaging device 105 may be powered at one of the following three power modes: print-ready mode 160, a sleep mode 170 and a low power or snooze mode 180. A first rate of power may be supplied to imaging device 105 during print-ready mode 160. In print-ready mode 160, replaceable components installed in imaging device 105 that are necessary to allow imaging device 105 to execute an imaging operation may be powered. Print-ready mode 160 may refer to a power mode prior to processing a print job (following start-up of imaging device 105 or waking up from sleep mode 170) or a power mode when a print job is detected. When in print-ready mode 160, imaging device 105 may be connected to network 120. Minimum to no power may be supplied to imaging device 105 when in sleep mode 170. In one example embodiment, sleep mode 170 may be referred to as an off mode. When imaging device 105 is in sleep mode 170, a connection of imaging device 105 to network 120 may be cut off. Imaging device 105 may not be able to communicate with computing device 110 or other devices over network 120 when in sleep mode 170. Additionally, power provided to allow communications between imaging device 105 and supply item 115 may be removed such that imaging device 105 may not be able to communicate with supply item 115 and/or other replaceable components installed therein when in sleep mode 170.

During snooze mode 180, a second rate of power less than the first rate of power may be supplied to imaging device 105. Relative to sleep mode 170, when imaging device 105 is in snooze mode 180, the second rate of power may be sufficient to allow supply item 115 to remain communicatively connected to imaging device 105. In one example embodiment, imaging device 105 may be disconnected from network 120 when in snooze mode 180. In another example embodiment, imaging device 105 may not be able to execute an imaging operation in snooze mode 180. Snooze mode 180 may be referred to as a standby mode. However, contrary to a known definition of a standby mode where a fixed, predetermined period is set prior to transitioning to an off or deep sleep mode, a usage behavior of imaging device 105 may be taken into consideration in determining an amount of time that imaging device 105 may spend in snooze mode 180, as will be discussed in connection with the figures that follow. In one example embodiment, a length of time for snooze mode 180 may be adapted based on an average amount of time that imaging device 105 spent in sleep mode 170. In one aspect, the average amount of time may be a running average.

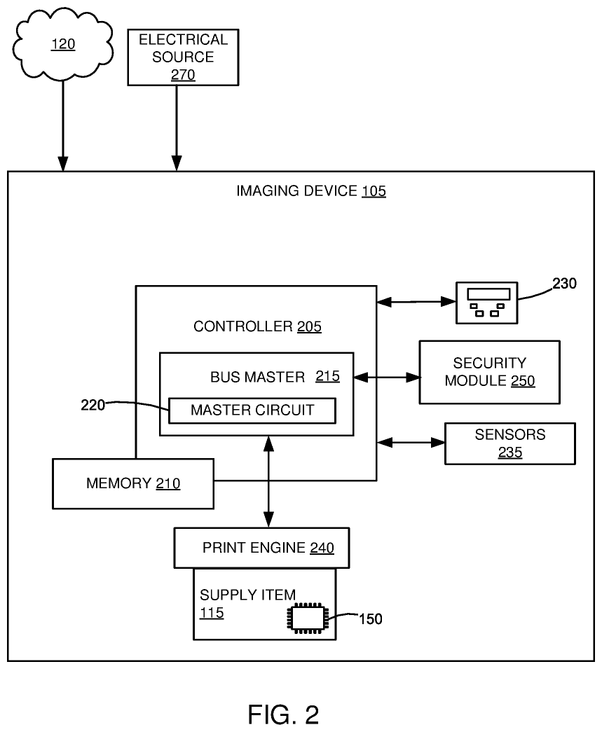

FIG. 2 is a block diagram showing different components of imaging device 105. Imaging device 105 may include a controller 205 and an associated memory 210. Controller 205 may include a bus master 215 having a processing circuitry or master I²C circuit 220. Controller 205 may be communicatively connected to a user interface 230 and a set of sensors 235. Bus master 215 may be communicatively connected to a print engine 240 and a security module 250. Supply item 115 having chip 150, as previously shown in FIG. 1, may be connected to print engine 240. Imaging device 105 may receive document 125 from computing device 110 via network 120 (see FIG. 1). Imaging device 105 may be connected to an electrical source 270 to provide power to components in imaging device 105.

Controller 205 may be formed as one or more application-specific integrated circuits. Controller 205 may communicate with print engine 240 to process data associated with printing document 125. Controller 205 may control print engine 240 when printing document 125 onto a media sheet. Controller 205 may be configured to control bus master 215 for communicating with supply item 115 and security module 250.

Memory 210 associated with controller 205 may be any memory device convenient for use with or capable of communicating with controller 205 for storing data. Memory 210 may be used to store data temporarily or permanently. Data stored in memory 210 may include print settings in imaging device 105, addresses of different slave components installed in imaging device 105 such as supply item 115, one or more print jobs such as document 125, and the like.

Bus master 215 may communicate with one or more slave components installed in imaging device 105 such as supply item 115. In one example embodiment, bus master 215 may communicate with supply item 115 via master I²C circuit 220. User interface 230 may be utilized by a user to provide inputs to imaging device 105. For example, user interface 230 may be utilized by a user to access and release document 125 for printing in imaging device 105.

Set of sensors 235 may include various sensors installed in imaging device 105. Sensors 235 may comprise a sensor for detecting a presence of media sheet in an input tray, a sensor for identifying a type of media in the input tray, a sensor for detecting presence of a user nearby imaging device 105, and/or other types of sensors. While set of sensors 235 are depicted as one block in FIG. 2, it is to be understood that set of sensors 235 may be installed as separate sensors in imaging device 105.

Print engine 240 may include any of a variety of different types of printing mechanisms including laser printing. Print engine 240 may include carriage 130 for holding at least one slave component such as supply item 115. Additionally, print engine 240 may include a motor(s), gear(s), and other components used for outputting document 125 onto a media sheet passed through imaging device 110. Following receipt of document 125 from computing device 110 through network 120, controller 205 may power on print engine 240 to allow printing of document 125.

Security module 250 may include instructions for authenticating supply item 115 for use in imaging device 105. In one example embodiment, security module 250 may include authentication functions, safety and operational interlocks in imaging device 105, and/or address-related functions related to addressable components in imaging device 105 which includes supply item 115. Security module 250 may operate in conjunction with bus master 215 to facilitate establishing connections between controller 105 and the various components and subassemblies connected to the shared bus system in imaging device 105, as will be further described below in connection with FIG. 3.

FIG. 3 is a block diagram of an example shared bus system 300 for imaging device 105. Shared bus system 300 includes bus master 215 including master I²C circuit 220. Shared bus system 300 further includes supply item 115 and security module 250. Supply item 115 and security module 250 may be communicatively connected to bus master 215 via a bus 305. Both chip 150 and security module 250 may be configured as slave devices that connect to bus master 215 via bus 305. Supply item 15 and security module 250 may include respective processing circuitries 320, 340 for communicating with master I²C circuit 220 of bus master 215.

In the present disclosure, shared bus system 300 may utilize an I²C interface protocol. However, it will also be appreciated by those of ordinary skill in the art that other serial bus communication protocols besides I²C, such as RS232 protocols, Serial Peripheral Interface Bus (SPI) protocols, System Management Bus (SMB) protocols, UNI/O bus protocols, or other protocols used in bus structures having master-slave configurations may be utilized in some alternative example embodiments. In yet other example embodiments, structures that facilitate communication between bus master 215 and the other components in imaging device 105 may operate using wireless technology.

Chip 150 of supply item 115 may include an I²C circuit 320, an address generator 325, and a memory 330. I²C circuit 320 may be a slave I²C circuit 320 for communicating with master I²C circuit 220 of bus master 215. Address generator 325 may include instructions to determine an address of supply item 115 along bus 305. In one example embodiment, address generator 325 may be a software algorithm stored in memory 330 of chip 150. In another example embodiment, address generator may form part of chip 150.

Security module 250 may include I²C circuit 340, an address generator 345, and a memory 350. I²C circuit 340 may be a slave I²C circuit 340 for communicating with master I²C circuit 220 of bus master 215. In one example embodiment, security module 250 may include instructions to calculate new addresses for components installed in imaging device 105 along bus 305, including supply item 115. Security module 250 may calculate the new addresses using a predetermined address change algorithm. The instructions may be stored in memory 350. While memory 350 may be shown as part of security module 250, memory 350 may be a memory separate from security module 250. Security module 250 may include instructions to return the calculated address values to bus master 215.

With reference to imaging device 105 in FIG. 2, to be able to send commands and responses along bus 305, power may be supplied to different components in shared bus system 300. A first amount of power may be supplied to master I²C circuit 220 to enable master I²C circuit 220 to send commands to slave I²C circuits 320 and 340. Another amount of power may be supplied to slave I²C circuits 320 and 340. Yet another amount of power may be supplied to other components in imaging device 105 such as to set of sensors 235 and print engine 240. Controller 205 may include instructions to determine what amount of power to supply to which component in imaging device 105. Controller 205 may further include instructions to start or to stop providing power to a predetermined component in imaging device 105.

As will be known in the art, it may take several separate processes to set imaging device 105 to print-ready mode 160 from sleep mode 170. In changing power modes in imaging device 105, one factor that may be taken account is how to optimize energy consumption in imaging device 105 such that energy efficiency requirements set by standardization bodies such as Energy Star and/or Blue Angel are met. Where imaging device 105 is in sleep mode 170 and where no print job is due, chip 150 of supply item 115 may be disconnected from bus master 215. Thus, when a print job to be printed in imaging device 105 is received while imaging device 105 is in sleep mode 170, a lengthy optimization process for reestablishing connections along bus 305 may transpire to switch imaging device 105 to print-ready mode 160. Power may be resupplied to components that are necessary to perform the operation, such as supply item 115. Respective slave circuits of supply items may be reconnected to the bus system. A longer time-to-first-print may be experienced by the imaging device user as a result.

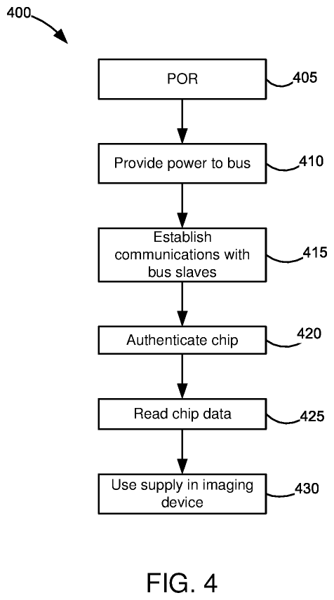

FIG. 4 is a flowchart showing an example method 400 of initializing chip 150 for imaging device 105, according to one example embodiment. Initializing chip 150 allows supply item 115 to be used in imaging device 105. Actions in blocks 405-430 may be performed by different components in imaging device 105. In one example embodiment, chip 150 may be initialized upon power on reset (POR). In another example embodiment, chip 150 may be initialized following a determination of controller 205 that imaging device 105 may be switched to print-ready mode 160 from snooze mode 180 or sleep mode 170. In other example embodiments, a partial initialization process may be performed to chip 150 in imaging device 105 such that some actions in example method 400 may be skipped or omitted.

At block 405, for purposes of discussion, example method 400 may be performed following a POR of imaging device 105. In one example embodiment, a POR may refer to when imaging device 105 is connected to electrical source 270. In other example embodiments, a POR may refer to when a power button (not shown) in imaging device 105 is turned on by a user, prompting power to be supplied to imaging device 105.

At block 410, controller 205 may provide power to bus master 215. At block 415, bus master 215 may establish communications with slave components along bus 305, which, in the present disclosure includes chip 150 of supply item 115 and security module 250. At block 420, bus master 215 may then authenticate chip 150. Authenticating chip 150 may include exchanging commands between chip 150 and security module 250. In other example embodiments, authenticating chip 150 may include determining whether responses of chip 150 to the commands sent by bus master 215 indicate chip 150 is from an original source or manufacturer. At block 425, following authentication of chip 150, bus master 215 may read data stored in memory 330 of chip 150. In reading data in chip 150, bus master 215 may be able to determine operational parameters and other settings of supply item 115 to allow use of supply item 115 in imaging device 105. At block 430, supply item 115 may be used in imaging device 105 to perform one or more operations.

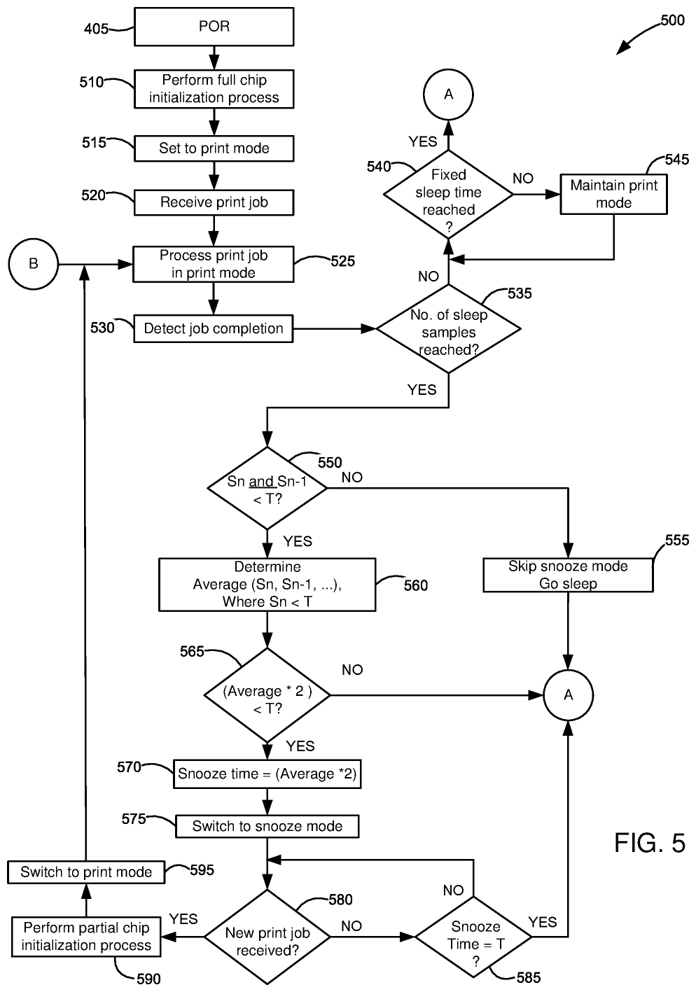

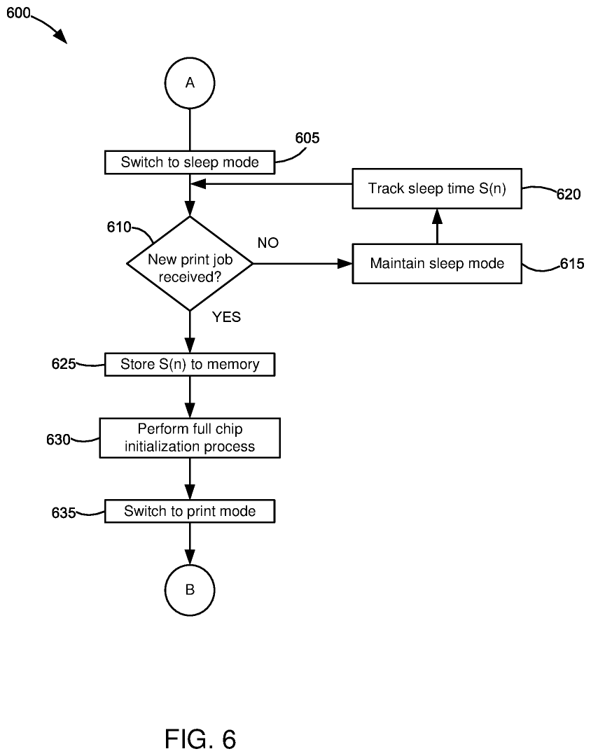

FIG. 5 is a flowchart showing an example method 500 for reducing a time-to-first-print in imaging device 105 when printing from sleep mode 170, according to one embodiment. Example method 500 may be performed by controller 205 of imaging device 105. References will be made to the components shown in FIGS. 1-3 and to the chip initialization process described in FIG. 4. Actions performed in blocks 505-595 will be discussed in conjunction with FIGS. 4 and 6.

In FIG. 5, at block 405, a POR of imaging device 105 may be performed. At block 510, upon POR, controller 205 may perform an initialization process for chip 150, such as is described above in connection with FIG. 4. Imaging device 105 may be automatically connected to network 120 upon POR. Since imaging device 105 underwent POR where connections among components in imaging device 105 are reset, controller 205 may perform a full initialization process for chip 150 so supply item 115 may be utilized to perform operations in imaging device 105. The full initialization process for chip 150, such as is described in example method 400, may also be performed for other components, such as security module 250, in imaging device 105.

At block 515, controller 205 may set imaging device 105 to print-ready mode 160 following POR (see FIG. 1). In print-ready mode 160, imaging device 105 is ready to perform operations such as printing. Imaging device 105 may also be ready to detect incoming print jobs when in the print-ready mode. Supply item 115 may be ready for use when imaging device 105 is in print-ready mode 160. At block 520, controller 205 may receive a print job while imaging device 105 is in a print-ready mode 160. In one example embodiment, imaging device 105 may receive document 125 over network 120. In another example embodiment, imaging device 105 may receive a print job from a user through user interface 230.

At block 525, controller 205 may instruct imaging device 105 to process the print job while in print-ready mode 160. Controller 205 may communicate with print engine 240 to perform the operation. In one example embodiment, imaging device 105 may print document 125 while supply item 115 is engaged with bus master 215. In other example embodiments, controller 205 may communicate with other components 240 to perform other operations, such as faxing or scanning.

At block 530, controller 205 may detect completion of the print job being performed at block 525. In one example embodiment and where imaging device 105 performed a printing operation in block 525, imaging device 105 may detect successful printing of document 125. In another example embodiment and where imaging device 105 performed a faxing operation in block 525, imaging device 105 may detect successful send-out of the fax message.

At block 535, controller 205 may determine whether a predetermined number of sleep time samples has been reached. Controller 205 may refer to memory 210 to determine the predetermined number of sleep time samples required. The sleep time samples may refer to a number of times that imaging device 105 has transitioned from sleep mode 170 to print-ready mode 160. Each sample may be a period of time that imaging device 105 has spent in sleep mode 170. The predetermined number of sleep time samples may be set to 3, for example. The sleep time samples may be stored in memory 210 of imaging device 105. In one example embodiment, as will be discussed in greater detail in connection with FIG. 6 below, memory 210 may include an instruction to store sleep time samples. In other example embodiments, controller 205 may include instructions to delete the sleep time samples and/or reset the number of sleep time samples following every POR.

At block 540, upon a determination that the number of sleep time samples has not been reached in imaging device 105, controller 205 may determine whether a fixed sleep time has been reached. In one example embodiment, the fixed or predetermined sleep time following completion of a print job may be set and stored in memory 210. For example, the predetermined sleep time may be set to about 15 minutes or other desired amount of time after completion of a print job and while imaging device 105 is not in use. At block 545, upon a determination that neither the predetermined number of sleep time samples nor the fixed sleep time has been reached following completion of a print job, controller 205 may maintain imaging device 105 in print-ready mode 160. Controller 205 may maintain imaging device 105 in print-ready mode 160 until a time that the fixed sleep time set in memory 210 is reached. Otherwise, upon a determination that the fixed sleep time has been reached following completion of the print job, controller 205 may proceed to example method 600 in

FIG. 6.

At block 550, upon a determination that the predetermined number of sleep time samples has been reached in memory 210, controller 205 may determine whether the most recent sleep time samples (labeled Sn and Sn-1, where n are the number of samples in the set) are less than a predetermined cross-over threshold (T) from snooze mode 180 to sleep mode 170. The two most recent sleep times may be compared with the predetermined threshold. In one example embodiment, the predetermined threshold may be stored in memory 210 of imaging device 105. In another example embodiment, the predetermined threshold may be set via user interface 230 of imaging device 105. In other example embodiments, the predetermined threshold may be set in a web server communicatively connected to imaging device 105. While the fixed sleep time (block 540) refers to a predetermined period of time that imaging device 105 may be set in sleep mode 170 following job completion, the predetermined threshold may be used as an indicator of whether or not imaging device 105 may be transitioned from print-ready mode 160 to snooze mode 180 or to sleep mode 170 based on sleep behaviors of imaging device 105. In one example embodiment, the predetermined threshold may be a predetermined period of time greater than the fixed sleep time. For example, the predetermined threshold may be set to 30 minutes and the fixed sleep time to 15 minutes.

At block 555, upon a determination in block 550 that the most recent sleep time samples are greater than or equal to the predetermined threshold, controller 205 of imaging device 105 may skip snooze mode 180 and may proceed to performing example method 600 in FIG. 6.

At block 560, upon a determination that the most recent sleep time samples Sn and Sn-1 are both less than the predetermined threshold, controller 205 may determine an average of sleep time samples stored in memory 210. In one example embodiment, controller 205 may determine the average of all sleep time samples which fall below the predetermined threshold. Controller 205 may identify which among the sleep time samples stored in memory 210 is less than the predetermined threshold for determining the average.

In one example embodiment, the average determined at block 560 may be multiplied by a predetermined multiplier M for comparison with the predetermined threshold. For example, the predetermined multiplier M may be set to at least 2. At block 565, controller 205 may determine whether or not a value of the average, when multiplied by the predetermined multiplier M, is less than the predetermined threshold. At block 568, upon a determination that the value is greater than or equal to the predetermined threshold, controller 205 may set a snooze time for snooze mode 180 to the predetermined threshold. Otherwise, at block 570, upon a determination that the value is less than the predetermined threshold, controller 205 may set the snooze time for snooze mode 180 to the value calculated in block 565.

Following blocks 568 and 570, at block 575, controller 205 may switch imaging device 105 from print-ready mode 160 (block 515) to snooze mode 180. As discussed above with respective to FIG. 1, snooze mode 180 may be a power mode in imaging device 105 where chip 150 remains connected to bus master 215. In other example embodiments, snooze mode 180 may be a power mode in imaging device 105 where imaging device 105 remains connected to network 120.

At block 580, controller 205 may determine whether or not there is a new print job while imaging device 105 is in snooze mode 180. In one example embodiment, controller 205 may track a period of time that imaging device 105 is in snooze mode 180 following the switch from print-ready mode 160. At block 585, upon a determination that there is no pending print job, controller 205 may determine whether or not the snooze time is equal to the predetermined threshold (block 550). As long as snooze time is less than the predetermined threshold set in imaging device 105, controller 205 may continue determining whether or not a new print job has been received. Otherwise, upon a determination that the snooze time reached the same value as the predetermined threshold, controller 205 may proceed to example method 600 in FIG. 6 where imaging device 105 is transitioned to sleep mode 170 from print-ready mode 160.

At block 590, upon a determination that a new print job is received in imaging device 105 while in snooze mode 180, controller 205 may perform a partial chip initialization process. In one example embodiment and with reference to FIG. 4, with chip 150 remaining connected to bus master 215 while imaging device 105 is in snooze mode 180, controller 205 may skip a full initialization process of chip 150 in imaging device 105 and read data in chip 150 directly so that supply item 115 may be used.

Referring back to FIG. 5, at block 595, following performing a partial initialization process for chip 150, imaging device 105 may be switched to print-ready mode 160 where imaging device 105 may have enough power to perform an operation. Block 595 may then loop back to block 525 where imaging device 105 processes the job in print-ready mode 160.

FIG. 6 is a flowchart showing an example method 600 for tracking a sleep time of imaging device 105, according to one example embodiment. For clarity, example method 600 is shown separately from example method 500 in FIG. 5. However, example method 600 may be incorporated into example method 500 in FIG. 5. Example method 600 is performed by controller 205 of imaging device 105, and references will be made to the components shown in FIGS. 1-3. Instructions on how to perform example methods 500 and 600 in FIGS. 5 and 6, respectively, may be stored in memory 210 of imaging device 105.

At block 605, controller 205 may switch imaging device 105 to sleep mode 170. As defined in the present disclosure and discussed above, sleep mode 170 may refer to a power mode in imaging device 105 where power supplied to components in imaging device 105 may be fully removed. In one example embodiment, imaging device 105 may be disconnected to network 120 when in sleep mode 170. In another example embodiment, connections between components in imaging device 105 may be removed when imaging device 105 is in sleep mode 170. For example, power may be removed from bus 305 and chip 150 of supply item 115 and/or security module 250 may be disconnected from bus master 215. In other example embodiments, sufficient power may remain in imaging device 105 to be able to receive print jobs while in sleep mode 170. Network 120 may include a data storage server for storing print jobs, and imaging device 105 may include instructions to detect a presence of document 125 on network 120 when in sleep mode 170.

With reference to FIG. 5 and in one example embodiment, imaging device 105 may be switched to sleep mode 170 upon a determination that the fixed sleep time has been reached (block 540). In another example embodiment, imaging device imaging device 105 may be configured to sleep mode 170 following a determination that the most recent sleep times are greater than or equal to the predetermined threshold (block 550) and/or that the snooze time has reached the same value as the predetermined snooze time cross-over threshold (block 585).

At block 610, controller 205 may determine whether a print job is received while imaging device 105 is in sleep mode 170. In one example embodiment, imaging device 105 may be able to detect any input while in sleep mode 170, prompting imaging device 105 to switch to print-ready mode 160. In this example embodiment, imaging device 105 may receive a job via user interface 230. For example, a user may insert a USB drive onto a port available on user interface 230 (not shown) or may retrieve a job from his or her associated profile on network 120 using user interface 230.

At block 615, as long as imaging device 105 has not received a print job while in sleep mode 170, controller 205 may maintain imaging device 105 in sleep mode 170. At block 620, controller 205 may track a period of time that imaging device 105 is in sleep mode 170 while waiting for a print job (i.e., the period of time being referred to as sleep time or Sn). The sleep time may begin from the time when imaging device 105 is in sleep mode 170 until a time that a print job is received. The sleep time may be expressed in minutes or other unit of time. Blocks 615 and 620 may be performed until a new print job is received.

At block 625, when controller 205 has determined that a new print job is received for imaging device 105, controller 205 may store the sleep time (Sn) tracked during the time that imaging device 105 is in sleep mode 170. In one example embodiment, each sleep time may be stored in memory 210 of imaging device 105 as one of the set of sleep time samples to be considered when switching to snooze mode 180 following print-ready mode 160. In other example embodiments, each sleep time may be stored in memory 330 of supply item 115.

At block 630, controller 205 may perform a full initialization process for chip 150. In one example embodiment, the full initialization process for chip 150 may be similar to the initialization process performed following POR (see block 510, FIG. 5). The full initialization process for chip 150 may refer to blocks 410-430 in FIG. 4. At block 635, following initialization of chip 150, controller 205 may switch imaging device 105 to print-ready mode 160 from sleep mode 170. Block 635 may then loop back to block 525 in FIG. 5 where imaging device 105 processes the job in print-ready mode 160.

Example methods 500 and 600 include actions which adjust a power mode in imaging device 105 based on its sleep history and not based on a fixed, predetermined sleep time. It will be observed that blocks 505-540 of FIG. 5 operate imaging device 105 in a sleep-print-sleep behavior that may be known in the prior art where, when a sleep time is reached, imaging device 105 is immediately transitioned to sleep mode 170 from print-ready mode 160. The present disclosure, however, and specifically the addition of blocks 615-625 in example method 600 of FIG. 6, keep track of a number of times that imaging device 105 has entered sleep mode 170 as well as how long imaging device 105 stays in sleep mode 170 to create a new power mode prior to sleep mode 170.

While the present disclosure describes the abovementioned example methods in the context of printing, the above example methods may also be utilized when other types of imaging operations in imaging device 105, such as scanning, faxing, and/or e-mailing, are performed. For example, imaging device 105 may include a scanner assembly (not shown) and may be configured to revert to print-ready mode 160 when a scan job is received. Thus, switching between one power mode to another may not only be based on print jobs.

It will be appreciated that the actions described and shown in the example flowcharts may be carried out or performed in any suitable order. It will also be appreciated that not all of the actions described in FIGS. 4-6 need to be performed in accordance with the example embodiments and/or additional actions may be performed in accordance with other example embodiments.

Many modifications and other embodiments of the disclosure set forth herein will come to mind to one skilled in the art to which this disclosure pertains having the benefit of the teachings presented in the foregoing descriptions and the associated drawings. Therefore, it is to be understood that the disclosure is not to be limited to the specific example embodiments disclosed and that modifications and other embodiments are intended to be included within the scope of the appended claims. Although specific terms are employed herein, they are used in a generic and descriptive sense only and not for purposes of limitation.

What is claimed is:

1. A method for reducing a time-to-first-print in an imaging device, comprising:
tracking a set of sleep times between print jobs in an imaging device;
determining whether a predetermined number of sleep times in the set of sleep times is reached; and
upon a positive determination,
identifying a first and a second most recent sleep times stored among the set of sleep times tracked;
determining whether each of the first and the second most recent sleep times are less than a predetermined threshold; and
upon a positive determination, determining a value based on an average of the first and the second most recent sleep times,
wherein the value is used as a period of time that the imaging device is powered at a snooze mode prior to transitioning to a sleep mode, and
wherein when a print job is received in the imaging device while in the snooze mode, the time-to-first-print from the snooze mode is faster than the time-to-first print when the print job is received while in the sleep mode further comprising, determining whether the value does not equal the predetermined threshold to determine whether to transition the imaging device to one of the sleep mode and the snooze mode.

2. The method of claim 1, wherein when the imaging device is in the snooze mode, a supply item chip in the imaging device remains connected with a controller of the imaging device.

3. The method of claim 2, wherein the supply item chip is circuitry for one of: a toner cartridge, an imaging kit, a photoconductor unit, a maintenance kit, a waste bottle, and a staple cartridge for installation in the imaging device.

4. The method of claim 1, wherein when the imaging device enters the sleep mode, connection between a supply item and a bus master in the imaging device is removed.

5. The method of claim 1, wherein the tracking the set of sleep times is performed following a determination that a fixed sleep time is reached.

6. The method of claim 1, wherein the predetermined number of sleep times is at least 3.

7. The method of claim 1, wherein upon a determination that each of the first and the second most recent sleep times are greater than or equal to the predetermined threshold, the imaging device is automatically transitioned to the sleep mode.

8. (canceled)

9. The method of claim 1, wherein upon a determination that the value is greater than or equal to the predetermined threshold, the predetermined threshold is set as a period of time that the imaging device is powered at the snooze mode.

10. The method of claim 1, wherein when no print job is received in the imaging device following the period of time that the imaging device is in the snooze mode, the imaging device is automatically transitioned to the sleep mode.

11. The method of claim 1, wherein the determining the value includes identifying, among the set of sleep times, a second set of sleep times that are less than the predetermined threshold;
determining an average of the second set of sleep times; and
determining the value by multiplying the average to a predetermined multiplier.

12. A method of managing power consumed in an imaging device based on usage, comprising:
determining whether a predetermined value of sleep time samples has been reached following execution of an operation in a print-ready mode;
upon a determination that the predetermined value has not been reached, determining whether a fixed sleep time is reached and switching the imaging device from the print-ready mode to a sleep mode; and
upon a determination that the predetermined value has been reached, determining a snooze period based on an average time of a set of previous times that the imaging device is in the sleep mode and setting the imaging device from the print-ready mode to a snooze mode for the snooze period,
wherein the imaging device is transitioned from the snooze mode to the sleep mode when the snooze period is over wherein when the imaging device is in the sleep mode, a power connection between each supply item installed in the imaging device and a bus controller of the imaging device is removed, and wherein when the imaging device is in the snooze mode, each supply item installed in the imaging device and a bus controller of the imaging device remains connected to the power connection.

13. (canceled)

14. The method of claim 12, further comprising determining, among a set of latest sleep times of the imaging device, a set of sleep times that is less than a predetermined threshold and identifying the average time using the set of sleep times that are less than the predetermined threshold.

15. The method of claim 12, wherein when a print job is received in the imaging device while in the snooze mode, a time-to-first-print of the imaging device from the snooze mode is faster than a time-to-first print of the imaging device when the print job is received while in the sleep mode.

16-20. (canceled)
